(19) United States
(12) Patent Application Publication
(10) Pub. No.: US 2025/0080138 A1
(43) Pub. Date: Mar. 6, 2025

(54) RADIO FREQUENCY TRANSCEIVER CIRCUIT AND ASSOCIATED CIRCUIT SET FOR PERFORMING DIGITAL PRE-DISTORTION COMPENSATION

(71) Applicant: Realtek Semiconductor Corp., HsinChu (TW)

(72) Inventors: Ping-Hsuan Tsai, HsinChu (TW); Chia-Jun Chang, HsinChu (TW)

(73) Assignee: Realtek Semiconductor Corp., HsinChu (TW)

(21) Appl. No.: 18/820,179

(22) Filed: Aug. 29, 2024

(30) Foreign Application Priority Data
Sep. 6, 2023 (TW) 112133783

(51) Int. Cl. H04B 1/00; H04B 1/04

(52) U.S. Cl. CPC H04B 1/005; H04B 1/04; H04B 2001/0425

(57) ABSTRACT

A radio frequency (RF) transceiver circuit includes a transmission circuit, a reception circuit, and a pre-distortion processing circuit. The transmission circuit is arranged to generate a transmission signal, wherein the transmission signal is transmitted to an antenna through a first pin. The reception circuit is arranged to receive a reception signal through a second pin. The pre-distortion processing circuit is arranged to receive a feedback signal through a third pin, and calculate distortion information of the transmission signal according to the feedback signal in order to generate and transmit a compensation signal to the transmission circuit for performing a pre-distortion compensation operation, wherein the feedback signal is generated according to a coupling signal of the transmission signal.

### BACKGROUND OF THE INVENTION

### 1. Field of the Invention

The present invention is related to radio frequency (RF) design, and more particularly, to an RF transceiver circuit and an associated circuit set that can obtain and analyze an appropriate feedback signal for performing digital pre-distortion compensation.

### 2. Description of the Prior Art

For an RF transmitter, an external front-end module (eFEM) is disposed between the RF transmitter and an antenna for achieving high power output. The eFEM, however, often generates non-linear phenomena in circuits, resulting in greater distortion in an RF signal transmitted by the antenna. In order to address the RF signal distortion problem, the RF signal to be transmitted by the antenna is typically obtained within the eFEM so the RF transmitter can perform a non-linear compensation via a digital pre-distortion method. The RF signal obtained within the eFEM is easily affected by other coupling signals, which may affect the efficacy of the digital pre-distortion compensation. As a result, how to obtain and analyze an appropriate RF signal to perform the digital pre-distortion compensation is an important issue.

### SUMMARY OF THE INVENTION

It is therefore one of the objectives of the present invention to provide an RF transceiver circuit and an associated circuit set that can obtain and analyze an appropriate feedback signal in order to perform digital pre-distortion compensation, to address the above-mentioned issues.

According to an embodiment of the present invention, an RF transceiver circuit is provided. The RF transceiver circuit comprises a transmission circuit, a reception circuit, and a pre-distortion processing circuit. The transmission circuit is arranged to generate a transmission signal, wherein the transmission signal is transmitted to an antenna through a first pin. The reception circuit is arranged to receive a reception signal through a second pin. The pre-distortion processing circuit is arranged to receive a feedback signal through a third pin, and calculate distortion information of the transmission signal according to the feedback signal to generate and transmit a compensation signal to the transmission circuit for performing a pre-distortion compensation operation, wherein the feedback signal is generated according to a coupling signal of the transmission signal.

According to an embodiment of the present invention, a circuit set is provided. The circuit set comprises an RF transceiver circuit, an external front-end module (eFEM), a coupler, and a matching circuit. The RF transceiver circuit comprises a first pin, a second pin, and a third pin. The eFEM comprises a power amplifier and a low-noise amplifier, wherein the power amplifier is arranged to amplify a transmission signal from the first pin for transmitting through an antenna; and the low-noise amplifier is arranged to receive a signal through the antenna to generate and transmit a reception signal to the second pin. The coupler is arranged to generate a coupling signal according to the transmission signal. The matching circuit is arranged to generate and transmit a feedback signal to the third pin according to the coupling signal in order for the RF transceiver circuit to perform a pre-distortion compensation operation.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a circuit set according to an embodiment of the present invention.

FIG. 2 is a diagram illustrating a pre-distortion processing circuit according to a first embodiment of the present invention.

FIG. 3 is a diagram illustrating a pre-distortion processing circuit according to a second embodiment of the present invention.

FIG. 4 is a diagram illustrating a pre-distortion processing circuit and a reception circuit according to a first embodiment of the present invention.

FIG. 5 is a diagram illustrating a pre-distortion processing circuit and a reception circuit according to a second embodiment of the present invention.

FIG. 6 is a diagram illustrating a pre-distortion processing circuit and a reception circuit according to a third embodiment of the present invention.

### DETAILED DESCRIPTION

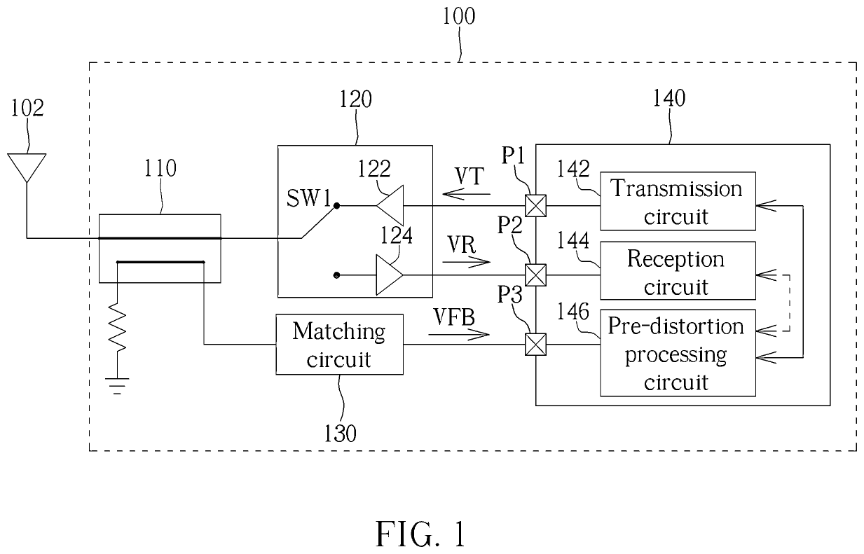

FIG. 1 is a diagram illustrating a circuit set 100 according to an embodiment of the present invention. As shown in FIG. 1, the circuit set 100 includes a coupler 110, an external front-end module (eFEM) 120, a matching circuit 130, and a radio frequency (RF) transceiver circuit 140. The RF transceiver circuit 140 is an RF transceiver chip, and includes at least three pins P1-P3, a transmission circuit 142, a reception circuit 144, and a pre-distortion processing circuit 146. The eFEM 120 includes a switch SW1, a power amplifier 122, and a low-noise amplifier 124. In this embodiment, the circuit set 100 may be disposed in any electronic device needing wireless signal transceiving, and may transmit and receive wireless signals through an antenna 102.

In operations of the circuit set 100, the RF transceiver circuit 140 may be arranged to perform signal transmission and signal reception. Specifically, when the RF transceiver circuit 140 performs the signal transmission, the transmission circuit 142 may generate a transmission signal VT, wherein the transmission circuit 142 may include a digital-to-analog converter (DAC), a mixer, a power amplifier, and other associated circuits. The transmission signal VT is transmitted to the eFEM 120 through the pin P1 and is amplified through the power amplifier 122, for transmitting to a remote electronic device through the switch SW1 and the antenna 102. When the RF transceiver circuit 140 performs the signal reception, the switch SW1 is switched to the low-noise amplifier 124. A reception signal VR is generated according to a signal received from the antenna 102 through the switch SW1 and the low-noise amplifier 124. The reception circuit 144 receives and processes the reception signal VR through the pin P2.

Since the non-linear phenomena of the power amplifier included in the transmission circuit 142 and the power amplifier 122 included in the eFEM 120, the transmission signal VT transmitted through the antenna 102 may be distorted. As a result, the present invention designs the coupler 110 and the matching circuit 130 for generating and transmitting a feedback signal VFB to the pre-distortion processing circuit 146 included in the RF transceiver circuit 140, in order to perform a compensation operation upon the transmission signal VT generated by the transmission circuit 142 in advance. Specifically, the transmission circuit 142 may generate multiple test signals as the transmission signal VT, wherein the multiple test signals have different intensity. The coupler 110 may be composed of two coupled transmission cables, and may be arranged to generate a coupling signal according to the transmission signal VT. It should be noted that, since the coupler 110 is disposed between the eFEM 120 and the antenna 102, the transmission signal VT is affected by the power amplifier 122 and is distorted, and the coupling signal reflects the distorted transmission signal VT. The matching circuit 130 may include a resistance matching circuit and/or a gain adjustment circuit (e.g., an attenuator) for adjusting the intensity of the coupling signal to generate the feedback signal VFB, wherein the feedback signal VFB is transmitted to the pre-distortion processing circuit 146 through the pin P3.

In this embodiment, since the matching circuit 130 and the eFEM 120 are two different components or two different chips, there will be better isolation between the matching circuit 130 and the power amplifier 122 of the eFEM 120, which prevents the transmission signal VT from being coupled to the matching circuit 130 through the eFEM 120 and affecting the feedback signal VFB. In addition, since the pin P3 is far away from the pin P1, the transmission signal VT is less likely to be coupled to the winding near the pin P3 through the winding near the pin P1. As mentioned above, the design of the circuit set 100 means the feedback signal VFB can accurately reflect the transmission signal VT transmitted through the antenna 102, without being affected by other signals. Therefore, the feedback signal VFB can be provided to the pre-distortion processing circuit 146 for performing better analysis and processing to thereby generate a better compensation signal. The transmission circuit 142 may perform a digital pre-distortion compensation operation according to the feedback signal VFB to cancel or reduce the non-linear effects of the eFEM 120. In this way, the pre-distortion compensated transmission signal VT still has better linearity after being processed by the eFEM 120.

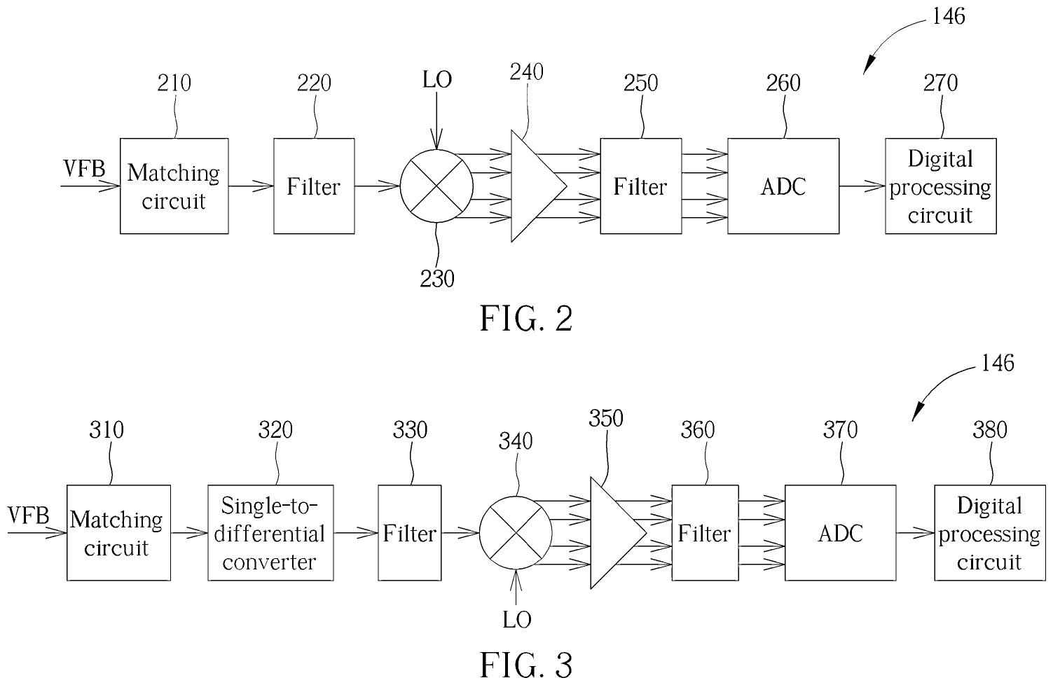

FIG. 2 is a diagram illustrating the pre-distortion processing circuit 146 according to a first embodiment of the present invention. As shown in FIG. 2, the pre-distortion processing circuit 146 includes a matching circuit 210, a filter 220, a mixer 230, an amplifier 240, a filter 250, an analog-to-digital converter (ADC) 260, and a digital processing circuit 270. In operations of the pre-distortion processing circuit 146, the matching circuit 210 includes a resistance matching circuit. The filter 220 may receive the feedback signal VFB from the matching circuit 210, and filter the feedback signal VFB to select a required frequency and generate a filtered signal. In this embodiment, the required frequency is a frequency of the transmission signal VT, so that the filter 220 can remove a mirror signal of the feedback signal VFB. The mixer 230 may perform a frequency down-conversion operation upon the filtered signal via an oscillation signal LO to generate a mixed signal. In this embodiment, the oscillation signal LO may include four oscillation signals with different phases, and the mixer 230 may perform the frequency down-conversion operation upon the filtered signal via the oscillation signal LO to generate four mixed signals, but the present invention is not limited thereto.

The amplifier 240 may amplify the mixed signal to generate an amplified signal. In this embodiment, the amplifier 240 may amplify the four mixed signals to generate four amplified signals, but the present invention is not limited thereto. The filter 250 may perform a low-pass filtering operation upon the amplified signal to generate a low-pass filtered signal. The ADC 260 may perform an analog-to-digital conversion operation upon the low-pass filtered signal to generate a digital signal. The digital processing circuit 270 may analyze and process the digital signal to generate and transmit a compensation signal to the transmission circuit 142 for performing the pre-distortion compensation operation. In an embodiment, the digital processing circuit 270 may obtain an original digital signal corresponding to the transmission signal VT (i.e., original digital values of the test signals) from the transmission circuit 142, and calculate distortion information of the transmission signal VT according to a difference between the original digital signal and the digital signal generated by the ADC 260, for generating the compensation signal. It should be noted that, since the operations of the digital processing circuit 270 regarding calculating the distortion information of the transmission signal VT and generating and transmitting the compensation signal to the transmission circuit 142 for performing the pre-distortion compensation operation are well known to those skilled in the art, further descriptions are not repeated in detail here.

FIG. 3 is a diagram illustrating the pre-distortion processing circuit 146 according to a second embodiment of the present invention. As shown in FIG. 3, the pre-distortion processing circuit 146 includes a matching circuit 310, a single ended-to-differential converter 320, a filter 330, a mixer 340, an amplifier 350, a filter 360, an ADC 370, and a digital processing circuit 380. In operations of the pre-distortion processing circuit 146, the matching circuit 310 includes a resistance matching circuit. The single ended-to-differential converter 320 may receive the feedback signal VFB from the matching circuit 310, and convert the feedback signal VFB into a differential signal. The filter 330 may filter the differential signal to select a required frequency and generate a filtered signal. In this embodiment, the required frequency is a frequency of the transmission signal VT. The mixer 340 may perform a frequency down-conversion operation upon the filtered signal via an oscillation signal LO to generate a mixed signal. In this embodiment, the oscillation signal LO may include four oscillation signals with different phases, and the mixer 340 may perform the frequency down-conversion operation upon the filtered signal via the oscillation signal LO, to generate four mixed signals, but the present invention is not limited thereto. The amplifier 350 may amplify the mixed signal to generate an amplified signal. The filter 360 may perform a low-pass filtering operation upon the amplified signal to generate a low-pass filtered signal. The ADC 370 may perform an analog-to-digital conversion operation upon the low-pass filtered signal to generate a digital signal. The digital processing circuit 380 may analyze and process the digital signal to generate a compensation signal, for the transmission circuit 142 to perform the pre-distortion compensation operation.

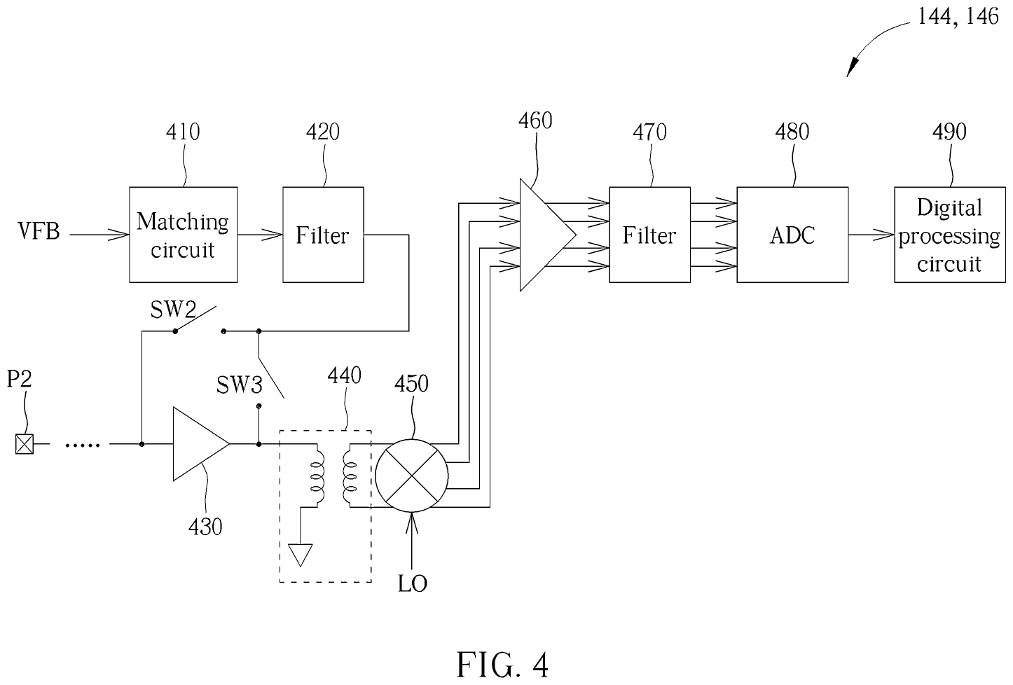

FIG. 4 is a diagram illustrating the pre-distortion processing circuit 146 and the reception circuit 144 according to a first embodiment of the present invention. In this embodiment, the pre-distortion processing circuit 146 and the reception circuit 144 include a matching circuit 410, a filter 420, a low-noise amplifier 430, two switches SW2 and SW3, a transformer 440, a mixer 450, an amplifier 460, a filter 470, an ADC 480, and a digital processing circuit 490. In this embodiment, the low-noise amplifier 430, the transformer 440, and the mixer 450 are components within the reception circuit 144, and the pre-distortion processing circuit 146 may generate the compensation signal by the mixer 450 within the reception circuit 144, which can reduce the number of components within the pre-distortion processing circuit 146 and reduce the production costs.

In detail, when the RF transceiver circuit 140 operates in a reception mode, the reception circuit 144 may obtain the reception signal VR through the antenna 102 and the eFEM 120. The reception signal VR is processed by the low-noise amplifier 430, the transformer 440, and the mixer 450 in sequence for transmitting to a back-end circuit (not shown in FIG. 4). At this moment, the pre-distortion processing circuit 146 may stop operating or be turned off, and the switches SW2 and SW3 may disconnect the connection between the reception circuit 144 and the pre-distortion processing circuit 146.

When the RF transceiver circuit 140 operates in a test mode, the transmission circuit 142 generates multiple test signals as the transmission signal VT, and the coupler 110 generates a coupling signal according to the transmission signal VT, wherein the feedback signal VFB is generated and transmitted to the pre-distortion processing circuit 146 after the coupling signal is processed by the matching circuit 130. At this moment, the switch SW1 within the eFEM 120 is switched to the power amplifier 122. Therefore, the reception circuit 144 will not receive signals from the antenna 102. In addition, one of the switches SW2 and SW3 may be enabled to connect the reception circuit 144 with the pre-distortion processing circuit 146. The matching circuit 410 includes a resistance matching circuit. The filter 420 may receive the feedback signal VFB from the matching circuit 410, and filter the feedback signal VFB to select a required frequency and generate a filtered signal. In this embodiment, the required frequency is a frequency of the transmission signal VT. If the switch SW2 is enabled, a processed signal is generated after the filtered signal is processed by the low-noise amplifier 430 and the transformer 440. If the switch SW3 is enabled, a processed signal is generated after the filtered signal is processed by the transformer 440. The mixer 450 may perform a frequency down-conversion operation upon the processed signal via an oscillation signal LO to generate a mixed signal. In this embodiment, the oscillation signal LO may include four oscillation signals with different phases, and the mixer 340 may perform the frequency down-conversion operation upon the filtered signal via the oscillation signal LO to generate four mixed signals, but the present invention is not limited thereto.

The amplifier 460 may amplify the mixed signal to generate an amplified signal. The filter 470 may perform a low-pass filtering operation upon the amplified signal to generate a low-pass filtered signal. The ADC 480 may perform an analog-to-digital conversion operation upon the low-pass filtered signal to generate a digital signal. The digital processing circuit 490 may analyze and process the digital signal to generate and transmit a compensation signal to the transmission circuit 142 for performing the pre-distortion compensation operation. In an embodiment, the digital processing circuit 490 may obtain an original digital signal corresponding to the transmission signal VT from the transmission circuit 142, and calculate distortion information of the transmission signal VT according to a difference between the original digital signal and the digital signal generated by the ADC 480, for generating the compensation signal. That is, when the RF transceiver circuit 140 operates in a test mode, the pre-distortion processing circuit 146 may calculate distortion information of the transmission signal VT according to the feedback signal VFB by the mixer 450, to generate and transmit the compensation signal to the transmission circuit 142 for performing the pre-distortion compensation operation.

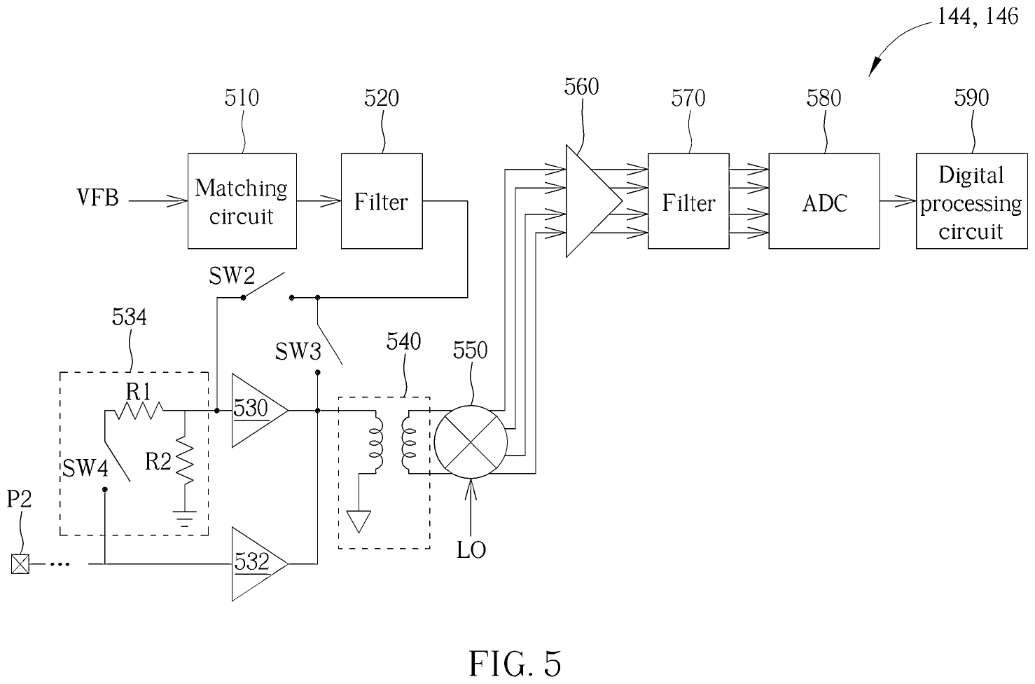

FIG. 5 is a diagram illustrating the pre-distortion processing circuit 146 and the reception circuit 144 according to a second embodiment of the present invention. In this embodiment, the pre-distortion processing circuit 146 and the reception circuit 144 include a matching circuit 510, a filter 520, two low-noise amplifiers 530 and 532, two switches SW2 and SW3, an isolation circuit 534 including a switch SW4 and two resistors R1 and R2, a transformer 540, a mixer 550, an amplifier 560, a filter 570, an ADC 580, and a digital processing circuit 590. In this embodiment, the low-noise amplifiers 530 and 532, the isolation circuit 534, the transformer 540, and the mixer 550 are components within the reception circuit 144, and the pre-distortion processing circuit 146 may generate the compensation signal by the mixer 550 within the reception circuit 144, which can reduce the number of components within the pre-distortion processing circuit 146 and reduce the production costs. In addition, since the distance between the pins P1 and P2 is relatively close, the transmission signal VT may affect the feedback signal VFB through the pin P2. In order to address this issue, the isolation circuit 534 is designed in this embodiment to reduce the interference from the pin P2.

In detail, when the RF transceiver circuit 140 operates in a reception mode, the reception circuit 144 may obtain the reception signal VR through the antenna 102 and the eFEM 120. The reception signal VR is processed by the low-noise amplifier 530/532, the transformer 540, and the mixer 550 in sequence for transmitting to a back-end circuit (not shown in FIG. 5). At this moment, the pre-distortion processing circuit 146 may stop operating or be turned off, and the switches SW2 and SW3 may disconnect the connection between the reception circuit 144 and the pre-distortion processing circuit 146.

When the RF transceiver circuit 140 operates in a test mode, the transmission circuit 142 generates multiple test signals as the transmission signal VT, and the coupler 110 generates a coupling signal according to the transmission signal VT, wherein the feedback signal VFB is generated and transmitted to the pre-distortion processing circuit 146 after the coupling signal is processed by the matching circuit 130. At this moment, the switch SW1 within the eFEM 120 is switched to the power amplifier 122. Therefore, the reception circuit 144 will not receive signals from the antenna 102. In addition, one of the switches SW2 and SW3 may be enabled to connect the reception circuit 144 with the pre-distortion processing circuit 146. The matching circuit 510 includes a resistance matching circuit. The filter 520 may receive the feedback signal VFB from the matching circuit 510, and filter the feedback signal VFB to select a required frequency and generate a filtered signal. If the switch SW2 is enabled, a processed signal is generated after the filtered signal is processed by the low-noise amplifier 530 and the transformer 540. If the switch SW3 is enabled, a processed signal is generated after the filtered signal is processed by the transformer 540. It should be noted that, since the low-noise amplifier 532 is turned off at this moment, and the isolation circuit 534 is designed to isolate the pin P2 and an input terminal of the low-noise amplifier 530, the intensity of the noise from the pin P2 or the intensity of the coupling signal will be attenuated and the filtered signal from the filter 520 will not be affected. In addition, since the operations of the mixer 550, the amplifier 560, the filter 570, the ADC 580, and the digital processing circuit 590 are similar to that of components with the same names in FIG. 4, further descriptions are not repeated in detail here.

It should be noted that the circuit architecture of the isolation circuit 534 shown in FIG. 5 is for illustration only, and the present invention is not limited thereto. As long as the isolation circuit 534 can attenuate the intensity of the noise from the pin P2 or the intensity of the coupling signal to prevent the filtered signal transmitted to the low-noise amplifier 530 through the switch SW2 from interference, the isolation circuit 534 can have different circuit architecture.

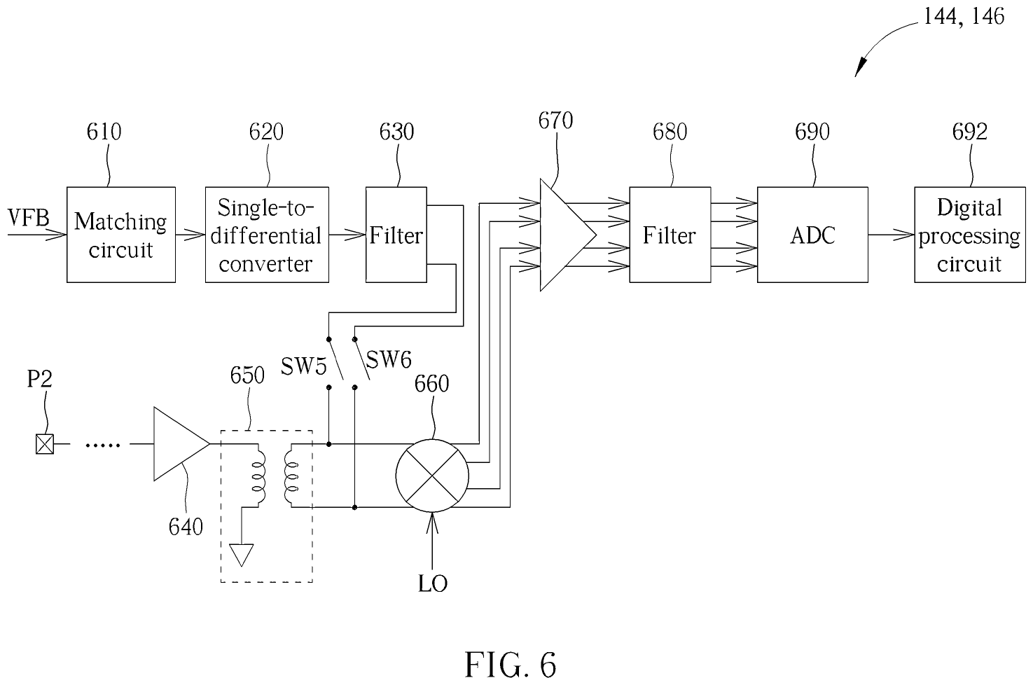

FIG. 6 is a diagram illustrating the pre-distortion processing circuit 146 and the reception circuit 144 according to a third embodiment of the present invention. In this embodiment, the pre-distortion processing circuit 146 and the reception circuit 144 include a matching circuit 610, a single ended-to-differential converter 620, a filter 630, a low-noise amplifier 640, two switches SW5 and SW6, a transformer 650, a mixer 660, an amplifier 670, a filter 680, an ADC 690, and a digital processing circuit 692. In this embodiment, the low-noise amplifier 640, the transformer 650, and the mixer 660 are components within the reception circuit 144, and the pre-distortion processing circuit 146 may generate the compensation signal by the mixer 660 within the reception circuit 144, which can reduce the number of components within the pre-distortion processing circuit 146 and reduce the production costs.

In detail, when the RF transceiver circuit 140 operates in a reception mode, the reception circuit 144 may obtain the reception signal VR through the antenna 102 and the eFEM 120. The reception signal VR is processed by the low-noise amplifier 640, the transformer 650, and the mixer 660 in sequence for transmitting to a back-end circuit (not shown in FIG. 6). At this moment, the pre-distortion processing circuit 146 may stop operating or be turned off, and the switches SW5 and SW6 may disconnect the connection between the reception circuit 144 and the pre-distortion processing circuit 146.

When the RF transceiver circuit 140 operates in a test mode, the transmission circuit 142 generates multiple test signals as the transmission signal VT, and the coupler 110 generates a coupling signal according to the transmission signal VT, wherein the feedback signal VFB is generated and transmitted to the pre-distortion processing circuit 146 after the coupling signal is processed by the matching circuit 130. At this moment, the switch SW1 within the eFEM 120 is switched to the power amplifier 122. Therefore, the reception circuit 144 will not receive signals from the antenna 102. In addition, the switches SW5 and SW6 may be enabled to connect the reception circuit 144 with the pre-distortion processing circuit 146. The matching circuit 610 includes a resistance matching circuit. The single ended-to-differential converter 620 may receive the feedback signal VFB from the matching circuit 610, and convert the feedback signal VFB into a differential signal. The filter 630 may filter the differential signal to select a required frequency and generate a filtered signal. In this embodiment, the required frequency is a frequency of the transmission signal VT. The mixer 660 may perform a frequency down-conversion operation upon the filtered signal via an oscillation signal LO to generate a mixed signal. In this embodiment, the oscillation signal LO may include four oscillation signals with different phases, and the mixer 340 may perform the frequency down-conversion operation upon the filtered signal via the oscillation signal LO to generate four mixed signals, but the present invention is not limited thereto.

The amplifier 670 may amplify the mixed signal to generate an amplified signal. The filter 680 may perform a low-pass filtering operation upon the amplified signal to generate a low-pass filtered signal. The ADC 690 may perform an analog-to-digital conversion operation upon the low-pass filtered signal to generate a digital signal. The digital processing circuit 692 may analyze and process the digital signal to generate a compensation signal in order for the transmission circuit 142 to perform the pre-distortion compensation operation. In an embodiment, the digital processing circuit 692 may obtain an original digital signal corresponding to the transmission signal VT from the transmission circuit 142, and calculate distortion information of the transmission signal VT according to a difference between the original digital signal and the digital signal generated by the ADC 690, for generating the compensation signal. That is, when the RF transceiver circuit 140 operates in a test mode, the pre-distortion processing circuit 146 may calculate distortion information of the transmission signal VT according to the feedback signal VFB by the mixer 660, to generate and transmit the compensation signal to the transmission circuit 142 for performing the pre-distortion compensation operation.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A radio frequency (RF) transceiver circuit, comprising:
a transmission circuit, arranged to generate a transmission signal, wherein the transmission signal is transmitted to an antenna through a first pin;
a reception circuit, arranged to receive a reception signal through a second pin; and
a pre-distortion processing circuit, arranged to receive a feedback signal through a third pin, and calculate distortion information of the transmission signal according to the feedback signal in order to generate and transmit a compensation signal to the transmission circuit for performing a pre-distortion compensation operation, wherein the feedback signal is generated according to a coupling signal of the transmission signal.

2. The RF transceiver circuit of claim 1, wherein the pre-distortion processing circuit comprises:
a first filter, arranged to filter the feedback signal to generate a filtered signal;
a mixer, arranged to perform a frequency down-conversion operation upon the filtered signal via an oscillation signal to generate a mixed signal;
a second filter, arranged to perform a low-pass filtering operation upon the mixed signal to generate a low-pass filtered signal;
an analog-to-digital converter, arranged to perform an analog-to-digital conversion operation upon the low-pass filtered signal to generate a digital signal; and
a digital processing circuit, arranged to calculate the distortion information of the transmission signal according to the digital signal, and generate and transmit the compensation signal to the transmission circuit for performing the pre-distortion compensation operation.

3. The RF transceiver circuit of claim 1, wherein the pre-distortion processing circuit comprises:
a single ended-to-differential converter, arranged to convert the feedback signal into a differential signal;
a first filter, arranged to filter the differential signal to generate a filtered signal;
a mixer, arranged to perform a frequency down-conversion operation upon the filtered signal via an oscillation signal to generate a mixed signal;
a second filter, arranged to perform a low-pass filtering operation upon the mixed signal to generate a low-pass filtered signal;
an analog-to-digital converter, arranged to perform an analog-to-digital conversion operation upon the low-pass filtered signal to generate a digital signal; and
a digital processing circuit, arranged to calculate the distortion information of the transmission signal according to the digital signal in order to generate and transmit the compensation signal to the transmission circuit for performing the pre-distortion compensation operation.

4. The RF transceiver circuit of claim 1, wherein the reception circuit comprises:
a low-noise amplifier;
a transformer; and
a mixer;
wherein when the RF transceiver circuit operates in a reception mode, the reception signal is processed by the low-noise amplifier, the transformer, and the mixer in sequence;
wherein when the RF transceiver circuit operates in a test mode, the pre-distortion processing circuit calculates the distortion information of the transmission signal according to the feedback signal by the mixer, for generating and transmitting the compensation signal to the transmission circuit to perform the pre-distortion compensation operation.

5. The RF transceiver circuit of claim 4, wherein the pre-distortion processing circuit comprises:
a first filter, arranged to filter the feedback signal to generate a filtered signal, wherein the transformer and the mixer in the reception circuit process the filtered signal to generate a mixed signal;
a second filter, arranged to perform a low-pass filtering operation upon the mixed signal to generate a low-pass filtered signal;
an analog-to-digital converter, arranged to perform an analog-to-digital conversion operation upon the low-pass filtered signal to generate a digital signal; and
a digital processing circuit, arranged to calculate the distortion information of the transmission signal according to the digital signal in order to generate and transmit the compensation signal to the transmission circuit for performing the pre-distortion compensation operation.

6. The RF transceiver circuit of claim 5, wherein the pre-distortion processing circuit comprises:
an isolation circuit, coupled between the second pin and an input terminal of the low-noise amplifier, and arranged to attenuate intensity of noise from the second pin or intensity of the coupling signal;
wherein the low-noise amplifier, the transformer, and the mixer in the reception circuit process the filtered signal to generate the mixed signal.

7. The RF transceiver circuit of claim 4, wherein the pre-distortion processing circuit comprises:
a single ended-to-differential converter, arranged to convert the feedback signal into a differential signal;
a first filter, arranged to filter the differential signal to generate a filtered signal, wherein the mixer in the reception circuit processes the filtered signal to generate a mixed signal;
a second filter, arranged to perform a low-pass filtering operation upon the mixed signal to generate a low-pass filtered signal;
an analog-to-digital converter, arranged to perform an analog-to-digital conversion operation upon the low-pass filtered signal to generate a digital signal; and
a digital processing circuit, arranged to calculate the distortion information of the transmission signal according to the digital signal in order to generate and transmit the compensation signal to the transmission circuit for performing the pre-distortion compensation operation.

8. A circuit set, comprising:
a radio frequency (RF) transceiver circuit, comprising a first pin, a second pin, and a third pin;
an external front-end module (eFEM), comprising a power amplifier and a low-noise amplifier, wherein the power amplifier is arranged to amplify a transmission signal from the first pin for transmitting through an antenna; and the low-noise amplifier is arranged to receive a signal through the antenna to generate and transmit a reception signal to the second pin;
a coupler, arranged to generate a coupling signal according to the transmission signal; and
a matching circuit, arranged to generate and transmit a feedback signal to the third pin according to the coupling signal in order for the RF transceiver circuit to perform a pre-distortion compensation operation.

9. The circuit set of claim 8, wherein the RF transceiver circuit comprises:
a transmission circuit, arranged to generate the transmission signal, wherein the transmission signal is transmitted to the eFEM through the first pin;
a reception circuit, arranged to receive the reception signal through the second pin; and
a pre-distortion circuit, arranged to receive the feedback signal from the third pin, and calculate distortion information of the transmission signal according to the feedback signal, to generate and transmit the compensation signal to the transmission circuit for performing the pre-distortion compensation operation.

10. The circuit set of claim 8, wherein the matching circuit comprises a resistance matching circuit and/or an attenuator.
